(19) United States
(12) Patent Application Publication
(10) Pub. No.: US 2011/0154384 A1
(43) Pub. Date: Jun. 23, 2011

(54) APPARATUS AND METHOD FOR OFFERING USER-ORIENTED SENSORY EFFECT CONTENTS SERVICE

(75) Inventor: Mal Hee KIM, Daejeon (KR)

(73) Assignee: Electronics and Telecommunications Research Institute, Daejeon (KR)

(21) Appl. No.: 12/883,742

(22) Filed: Sep. 16, 2010

(30) Foreign Application Priority Data
Dec. 21, 2009 (KR) 10-2009-0127719
Mar. 9, 2010 (KR) 10-2010-0020907

(51) Int. Cl. H04H 60/33

(52) U.S. Cl. 725/9

(57) ABSTRACT

The present invention relates to an apparatus and a method for offering a user-oriented sensory effect contents service. An apparatus for offering a user-oriented sensory effect contents service according to an embodiment of the present invention includes: a user context manager managing a user context including information on a user or information on user circumstances; and a device controller controlling a contents playing device capable of playing contents in accordance with the user context.

### CROSS-REFERENCE TO RELATED APPLICATIONS

This application claims priority under 35 U.S.C. §119 to Korean Patent Application No. 10-2009-127719, filed on Dec. 21, 2009, and Korean Patent Application No. 10-2010-0020907, filed on Mar. 9, 2010 in the Korean Intellectual Property Office, the disclosure of which is incorporated herein by reference in its entirety.

### BACKGROUND OF THE INVENTION

1. Field of the Invention

The present invention relates to an apparatus and a method for offering a user-oriented sensory effect contents service, and more particularly, to an apparatus and a method for offering a user-oriented sensory effect contents service that allow a user to enjoy a sensory effect of contents suitable for a user context through various contents playing devices.

2. Description of the Related Art

The known content service offering apparatus does not consider information on a user, information on circumstances of the user, and user preference information at the time of using contents.

Further, the known content service offering apparatus does not utilize various ubiquitous sensor network (USN)-based sensors and sensor networks by considering the information on the user, the information on circumstances of the user, and the user preference information at the time of using the contents.

### SUMMARY OF THE INVENTION

An object of the present invention is to provide an apparatus for offering a user-oriented sensory effect contents service.

Another object of the present invention is to provide a method for offering a user-oriented sensory effect contents service.

The objects of the present invention are not limited to the above-mentioned objects and other undescribed objects will be apparently appreciated by those skilled in the art from the following descriptions.

In order to achieve the above-mentioned objects, an apparatus for offering a user-oriented sensory effect contents service according to an embodiment of the present invention includes: a user context manager managing a user context including information on a user or information on user circumstances; and a device controller controlling a contents playing device capable of playing contents in accordance with the user context.

An apparatus for offering a user-oriented sensory effect contents service according to another embodiment of the present invention includes: a device searcher searching a contents playing device capable of playing contents; a user context manager managing a user context including information on a user or information on user circumstances; and a device controller diverging the contents every predetermined time during deployment of the contents and controlling the searched contents playing device to play the diverged contents in accordance with the user context at the divergence point.

A method for offering a user-oriented sensory effect contents service according to yet another embodiment of the present invention includes: managing a user context including information on a user or information on user circumstances; and controlling a contents playing device capable of playing contents in accordance with the user context.

Details of other embodiments are included in the detailed description and the accompanying drawings.

According to an embodiment of the present invention, an apparatus and a method for offering a user-oriented sensory effect contents service can control a contents playing device suitable for a user context.

Further, a user can enjoy a sensory effect of contents considering information on the user and information on user circumstances through various contents playing devices.

### BRIEF DESCRIPTION OF THE DRAWINGS

FIG. 1 is a conceptual diagram showing an apparatus and a method for offering a user-oriented sensory effect content service according to an embodiment of the present invention;

FIG. 2 is a block diagram showing an apparatus for offering a user-oriented sensory effect content service according to another embodiment of the present;

FIG. 3 is a block diagram showing an apparatus for offering a user-oriented sensory effect content service according to yet another embodiment of the present invention;

FIG. 4 is a block diagram showing an apparatus for offering a user-oriented sensory effect content service according to still another embodiment of the present invention;

FIG. 5 is a block diagram showing an apparatus for offering a user-oriented sensory effect content service according to still yet another embodiment of the present invention;

FIG. 6 is a block diagram showing an apparatus for offering a user-oriented sensory effect content service according to still yet another embodiment of the present invention; and

FIG. 7 is a block diagram showing an apparatus for offering a user-oriented sensory effect content service according to still yet another embodiment of the present invention.

### DETAILED DESCRIPTION OF THE PREFERRED EMBODIMENTS

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

Hereinafter, an embodiment of the present invention will be described in detail with reference to the accompanying drawings.

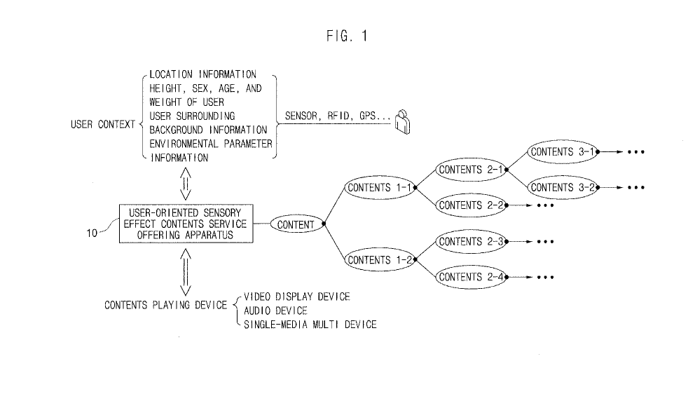

Referring to FIG. 1, an apparatus and a method for offering a user-oriented sensory effect content service according to embodiments of the present invention will be described.

FIG. 1 is a conceptual diagram showing an apparatus and a method for offering a user-oriented sensory effect content service according to an embodiment of the present invention.

As shown in FIG. 1, the user-oriented sensory effect contents service offering apparatus 10 according to the embodiments of the present invention manages a user context and controls, in accordance with the user context, a content playing device capable of playing contents in accordance with deployment of contents.

Herein, the user context may include information on a user or information on user circumstances. For example, the user context may include at least one of location information, sex information, age information, height information, and weight information of the user, a user surrounding background information, environment parameter information of user peripheral area, and user history information.

Meanwhile, the user context may be acquired by user's direct input, storage devices (e.g., memory, hard disk, etc.), sensors (e.g., pressure sensor, temperature sensor, humidity sensor, gas sensor, wind speed sensor, acceleration sensor, fingerprint reader, sensor network, etc.), a GPS, an RFID tag, an image processing technique, etc.

Further, the contents playing device may be a video display device, or an audio device.

In addition, the contents playing device may be a single-media multi device (SMMD) generating a sensory effect by stimulating the user's five senses, such as an aroma dispenser, a vibrator, a temperature controller, a pressure controller, etc.

Meanwhile, the user-oriented sensory effect contents offering apparatus 10 according to the embodiments of the present invention may manage the user context and control the content playing device to play contents diverged in accordance with the user context.

For example, the user-oriented sensory effect contents offering apparatus 10 according to the embodiments of the present invention may receive contents having divergence points to play the received contents at each divergence point in accordance with the user context or the user-oriented sensory effect contents offering apparatus 10 according to the embodiments of the present invention may generate the divergence points in the contents to play the generated contents at each divergence point in accordance with the user context.

The example described in detail, the user-oriented sensory effect contents offering apparatus 10 according to the embodiments of the present invention may control the aroma dispenser and the temperature controller depending on the user context, i.e., a user's location and temperature, humidity, etc. at the corresponding location at each divergence point to appropriately service contents in accordance with user information or circumstances at a divergence point.

That is, deployment of the contents may be changed depending on the user information or circumstances for each divergence point.

When illustratively described, as shown in FIG. 1, the contents may have the divergence point (DP) at which the contents are diverged during deployment of the contents and if the divergence point is present while the contents are deployed, the contents may be diverged.

The contents may be diverged into contents 1-1 and contents 1-2 at the divergence point. The contents 1-1 may be diverged into contents 2-1 and contents 2-2 at another divergence point. Likewise, if yet another divergence point is present, the contents may be diverged at the divergence point.

Therefore, the user-oriented sensory effect contents offering apparatus 10 according to the embodiments of the present invention may manage the user context and control the content playing device to play the diverged contents variously deployed in accordance with the user context.

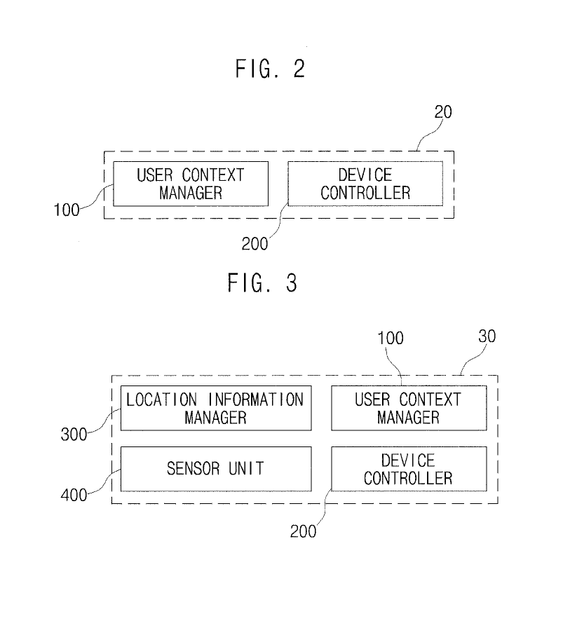

Referring to FIG. 2, an apparatus for offering a user-oriented sensory effect content service according to an embodiment of the present invention will be described.

FIG. 2 is a block diagram showing an apparatus for offering a user-oriented sensory effect content service according to an embodiment of the present invention.

Specifically, referring to FIG. 2, the user-oriented sensory effect contents service offering apparatus 20 according to the embodiment of the present invention includes a user context manager 100 and a device controller 200.

The user context manger 100 manages a user context including information on a user or information on the user's circumstances.

The device controller 200 controls a contents playing device capable of playing contents in accordance with the user context.

Further, the device controller 200 may diverge the contents during deployment of the contents and control the contents playing device to play the diverged contents in accordance with the user context.

Further, the device controller 200 may diverge the contents every predetermined time during the deployment of the contents and control the contents playing device to play the diverged contents in accordance with the user context at the divergence point. Meanwhile, the user context may be updated in accordance with the collected user information or user circumstances information and the user context manger 100 may manage the updated user context.

Further, the device controller 200 may diverge the contents every user's direction point during the deployment of the contents and control the contents playing device to play the diverged contents in accordance with the user context at the divergence point. Meanwhile, the user context may be updated in accordance with the collected user information or user circumstances information. Further, the user context manager 100 may manage the updated user context.

Referring to FIG. 3, another embodiment of the present invention will be described. FIG. 3 is a block diagram showing an apparatus for offering a user-oriented sensory effect content service according to another embodiment of the present.

Herein, components that perform the same functions as the components shown in FIG. 2 refer to the same reference numerals and the corresponding components will not be described in detail.

Referring to FIG. 3, the user-oriented sensory effect contents service offering apparatus 30 according to the embodiment of the present invention includes a user context manager 100 and a device controller 200 and in addition, may further include a location information manager 300 and a sensor unit 400.

The location information manager 300 tracks a user's location to acquire and manage user's location information.

The sensor unit 400 senses the user's circumstances to acquire environmental parameter information of a peripheral area.

Meanwhile, the user context manager 100 may receive the user's location information and the environmental parameter information from the location information manager 300 and the sensor unit 400.

Further, the location information manager 300 may acquire the user's location information through user's direct input, storage devices (e.g., memory, hard disk, etc.) storing the user's location information, a GPS, an RFID tag, an image processing technique, etc.

Further, the environmental parameter information of the peripheral area acquired by the sensor unit 400 may include pressure, temperature, humidity, gas, wind speed, acceleration, a fingerprint, etc. The sensor unit 400 may sense the user circumstances through various sensors (e.g., pressure sensor, temperature sensor, humidity sensor, gas sensor, wind speed sensor, acceleration sensor, fingerprint reader, sensor network, etc.) and acquire the environmental parameter information of the peripheral area.

Meanwhile, the user context manager 100 receives the user's location information and the environmental parameter information from the location information manager 300 and the sensor unit 400 to manage the user context and the device controller 200 may more effectively control the content playing device suitable for the user context. Further, a user may enjoy a sensory effect of contents considering the user information and the user circumstances information through various contents playing devices.

Further, the user context may include at least one of location information, sex information, age information, height information, and weight information of the user, a user surrounding background information, environment parameter information of user peripheral area, and user history information.

Herein, the user history information may include any one of a user's past context which was managed by the user context manager 200, a user's contents using history, a playing history of the contents playing device, and user preference to the contents and the contents playing device.

In addition, the user history information may be the user preference to the contents and the contents playing device according to user's direct input.

Besides, the user context manager 100 may acquire user preference information on the user preference to at least one of the contents and the contents playing device by using the user history information and the device controller 200 may control the contents playing device in accordance with the user preference information.

Moreover, the user preference information may include any one of a user control information input value of the contents playing device, an operation duration of the contents playing device, the operation intensity of the contents playing device, an operation frequency of the contents playing device, and an operation sequence of the contents playing device.

Further, the user preference information may be changed depending on user's input.

Meanwhile, the user context manager 100 may generate meta data including the user preference information by matching the user preference information with the contents playing device and the device controller 200 may control the contents playing device by using the meta data including the user preference information.

The meta data may be data structured so as for the user or the user-oriented sensory effect contents offering apparatus 30 according to the embodiment of the present invention to easily access and easily modify the user context and desired information among a lot of information relating to the contents playing device.

Meanwhile, the user context manager 100 may use the meta data in order to provide the sensory effect considering the user preference information and the user information and the user circumstances information.

Further, the user context manager 100 may use the meta data in order to offer a sensory effect of the user's desired contents to the user by selecting various contents playing devices suitable for user preference.

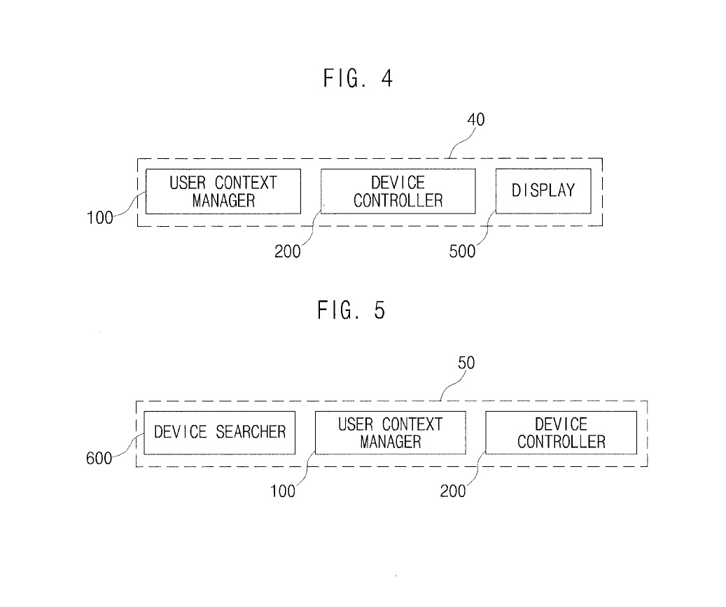

Referring to FIG. 4, yet another embodiment of the present invention will be described. FIG. 4 is a block diagram showing an apparatus for offering a user-oriented sensory effect content service according to yet another embodiment of the present invention.

Herein, components that perform the same functions as the components shown in FIG. 2 refer to the same reference numerals and the corresponding components will not be described in detail.

Referring to FIG. 4, the user-oriented sensory effect contents service offering apparatus 40 according to the embodiment of the present invention includes a user context manager 100 and a device controller 200 and in addition, may further include a display 500.

The display 500 displays control information of the contents playing device and the user context to the user.

Therefore, when the device controller 200 controls the contents playing device suitable for the user context, the user can verify the control information of the contents playing device and the user context through the display 500.

Meanwhile, the user verifies the control information of the contents playing device and the user context through the display 500 to modify and manage the user context by user's direct input or changing the user preference information and change and manage the contents playing device controlled by the device controller 200.

Referring to FIG. 5, still another embodiment of the present invention will be described. FIG. 5 is a block diagram showing an apparatus for offering a user-oriented sensory effect content service according to still another embodiment of the present invention.

Referring to FIG. 5, the user-oriented sensory effect contents service offering apparatus 50 according to the embodiment of the present invention includes a user context manager 100 and a device controller 200 and in addition, may further include a device searcher 600.

The user context manger 100 manages a user context including information on a user or information on user circumstances.

The device controller 200 controls a contents playing device capable of playing contents in accordance with the user context.

The device searcher 600 searches the contents playing device capable of playing the contents.

Meanwhile, the contents playing device searched by the device searcher 600 may be a video display device or an audio device.

Further, the contents playing device searched by the device searcher 600 may be a single-media multi device (SMMD) generating a sensory effect by stimulating user's five senses, such as an aroma dispenser, a vibrator, a temperature controller, a pressure controller, etc.

In addition, the device searcher 600 may search the contents playing device every predetermined time.

Besides, the device searcher 600 may search the contents playing device every user's direction point.

Moreover, the device searcher 600 may search the contents playing device every contents divergence point.

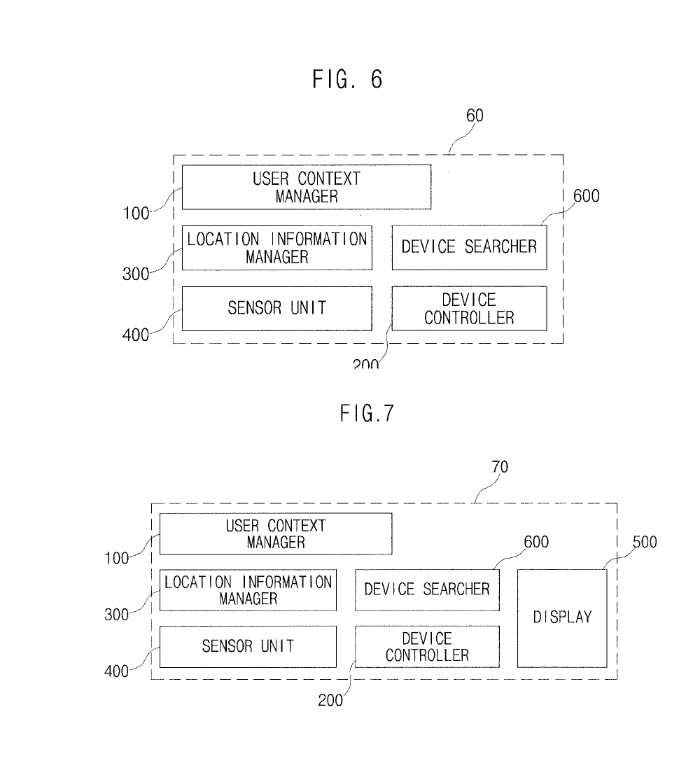

Referring to FIG. 6, still yet another embodiment of the present invention will be described. FIG. 6 is a block diagram showing an apparatus for offering a user-oriented sensory effect content service according to still yet another embodiment of the present invention.

Herein, components that perform the same functions as the components shown in FIG. 5 refer to the same reference numerals and the corresponding components will not be described in detail.

Referring to FIG. 6, the user-oriented sensory effect contents service offering apparatus 60 according to the embodiment of the present invention includes a user context manager 100, a device controller 200, and a device searcher 600 and in addition, may further include a location information manager 300 and a sensor unit 400.

The location information manager 300 tracks a user's location to acquire and manage the user's location information.

The sensor unit 400 senses user circumstances to acquire environmental parameter information of a peripheral area.

Meanwhile, the device searcher 600 may search a contents playing device capable of playing contents in accordance with the user's location information and the environmental parameter information received from the location information manager 300 and the sensor unit 400.

Further, the device controller 200 may control a contents playing device searched by the device searcher 600 in accordance with the user's location information and the environmental parameter information, which is suitable for the user context.

In addition, the device searcher 600 may search the contents playing device in accordance with a change of the user's location or a change of the environmental parameter information depending on the change of the user's location.

Besides, although the user-oriented sensory effect contents service offering apparatus 60 according to the embodiment of the present invention does not include the location information manager 300 and the sensor unit 400 in FIG. 6, the device searcher 600 may search a contents playing device capable of playing the contents in accordance with environmental parameter information of a peripheral area acquired by sensing the user's location information and the user circumstances.

In this case, the environmental parameter information of the peripheral area acquired by sensing the user's location information and the user's circumstances may be acquired through the user's direct input, storage devices (e.g., memory, hard disk, etc.), sensors (e.g., pressure sensor, temperature sensor, humidity sensor, gas sensor, wind speed sensor, acceleration sensor, fingerprint reader, sensor network, etc.), a GPS, an RFID tag, an image processing technique, etc.

Referring to FIG. 7, still yet another embodiment of the present invention will be described. FIG. 7 is a block diagram showing an apparatus for offering a user-oriented sensory effect content service according to still yet another embodiment of the present.

Referring to FIG. 7, the user-oriented sensory effect contents service offering apparatus 70 according to the embodiment of the present invention includes a user context manager 100, a device controller 200, a location information manager 300, a sensor unit 400, a display 500, and a device searcher 600.

The user context manger 100 manages a user context including information on a user or information on user circumstances.

The device controller 200 controls a contents playing device capable of playing contents in accordance with the user context.

The location information manager 300 tracks a user's location to acquire and manage user's location information.

The sensor unit 400 senses user circumstances to acquire environmental parameter information of a peripheral area.

The display 500 displays control information of the contents playing device and the user context to the user.

The device searcher 600 searches the contents playing device capable of playing the contents.

Herein, the user history information may include any one of a user's past context, a user's contents using history, a playing history of the contents playing device, and user preference to the contents and the contents playing device.

In addition, the user history information may be the user preference to the contents and the contents playing device according to user's direct input.

Herein, the user context manager 100 may collect information on the user preference to at least one of the contents and the contents playing device and the device controller 200 may control the contents playing device in accordance with the user preference information.

Meanwhile, the user preference information may include any one of a user control information input value of the contents playing device, an operation duration of the contents playing device, the operation intensity of the contents playing device, an operation frequency of the contents playing device, and an operation sequence of the contents playing device.

Further, the user preference information may be changed depending on user selection.

Meanwhile, the location information manager 300 may acquire the user's location information through the user's direct input, storage devices (e.g., memory, hard disk, etc.) storing the user's location information, a GPS, an RFID tag, an image processing technique, etc.

Meanwhile, the environmental parameter information of the peripheral area acquired by the sensor unit 400 may include pressure, temperature, humidity, gas, wind speed, acceleration, a fingerprint, etc. The sensor unit 400 may sense the user's circumstances through various sensors (e.g., pressure sensor, temperature sensor, gas sensor, wind speed sensor, acceleration sensor, fingerprint reader, sensor network, etc.) and acquire the environmental parameter information of the peripheral area.

Meanwhile, the device searcher 600 may search a contents playing device capable of playing contents in accordance with the user's location information and the environmental parameter information received from the location information manager 300 and the sensor unit 400.

Meanwhile, the user context may include at least one of location information, sex information, age information, height information, and weight information of the user, a user surrounding background information, environment parameter information of user peripheral area, and user history information.

While certain embodiments have been described above, it will be understood to those skilled in the art that the embodiments described can be modified into various forms without changing technical spirits or essential features. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for offering a user-oriented sensory effect contents service, comprising:
a user context manager managing a user context including information on a user or information on user's circumstances; and
a device controller controlling a contents playing device capable of playing contents in accordance with the user context.

2. The apparatus for offering a user-oriented sensory effect contents service of claim 1, wherein the device controller diverges the contents during deployment of the contents and controls the contents playing device to play the diverged contents in accordance with the user context.

3. The apparatus for offering a user-oriented sensory effect contents service of claim 2, wherein the device controller diverges the contents every predetermined time during deployment of the contents and controls the contents playing device to play the diverged contents in accordance with the user context at the divergence point, and the user context is updated in accordance with the user information or the user's circumstances information.

4. The apparatus for offering a user-oriented sensory effect contents service of claim 2, wherein the device controller diverges the contents every user's direction point during deployment of the contents and controls the contents playing device to play the diverged contents in accordance with the user context at the divergence point, and the user context is updated in accordance with the collected user information or user circumstances information.

5. The apparatus for offering a user-oriented sensory effect contents service of claim 1, wherein the contents playing device is any one of a video display device, an audio device, and a single-media multi device (SMMD) generating a sensory effect by simulating user's five senses.

6. The apparatus for offering a user-oriented sensory effect contents service of claim 1, wherein the user context manager manages the user contexts including at least one of location information, sex information, age information, height information, and weight information of the user, a user surrounding background information, environment parameter information of user peripheral area, and user history information.

7. The apparatus for offering a user-oriented sensory effect contents service of claim 6, further comprising:
a location information manager tracking the user's location to acquire and manage the user's location information; and
a sensor unit sensing the user circumstances to acquire the environmental parameter information of the peripheral area,
wherein the user context manager receives the user's location information and the environmental parameter information from the location information manager and the sensor unit.

8. The apparatus for offering a user-oriented sensory effect contents service of claim 6, wherein the user context manager collects information on the user preference to at least one of the contents and the contents playing device by using the user history information, and
the device controller controls the contents playing device in accordance with the user preference information.

9. The apparatus for offering a user-oriented sensory effect contents service of claim 8, wherein the device controller controls the contents playing device in accordance with the user preference information including any one of a user control information input value of the contents playing device, an operation duration of the contents playing device, the operation intensity of the contents playing device, an operation frequency of the contents playing device, and an operation sequence of the contents playing device.

10. The apparatus for offering a user-oriented sensory effect contents service of claim 8, wherein the device controller is capable of changing the user preference information depending on the user selection.

11. The apparatus for offering a user-oriented sensory effect contents service of claim 8, wherein the user context manager generates meta data including the user preference information by matching the user preference information with the contents playing device, and
the device controller controls the contents playing device by using the meta data including the user preference information.

12. The apparatus for offering a user-oriented sensory effect contents service of claim 1, further comprising:
a display displaying control information of the contents playing device and the user context to the user.

13. An apparatus for offering a user-oriented sensory effect contents service, comprising:
a device searcher searching a contents playing device capable of contents;
a user context manager managing a user context including information on a user or information on user circumstances; and
a device controller diverging the contents every predetermined time during deployment of the contents and controlling the contents playing device to play the diverged contents in accordance with the user context at the divergence point.

14. The apparatus for offering a user-oriented sensory effect contents service of claim 13, wherein the device searcher searches the contents playing device capable of playing the contents in accordance with environmental parameter information of a peripheral area acquired by sensing the user's location information and the user circumstances.

15. A method for offering a user-oriented sensory effect contents service, comprising:
managing a user context including information on a user or information on user circumstances; and
controlling a contents playing device capable of playing contents in accordance with the user context.

16. The method for offering a user-oriented sensory effect contents service of claim 15, wherein the controlling includes diverging the contents during deployment of the contents and controlling the contents playing device to play the diverged contents in accordance with the user context.

17. The method for offering a user-oriented sensory effect contents service of claim 15, wherein the controlling includes diverging the contents every user's direction point during deployment of the contents and controlling the contents playing device to play the diverged contents in accordance with the user context at the divergence point, and
the user context is updated in accordance with the user information or the user circumstances information.

18. The method for offering a user-oriented sensory effect contents service of claim 15, wherein the controlling includes diverging the contents every predetermined time during deployment of the contents and controlling the contents playing device to play the diverged contents in accordance with the user context at the divergence point, and
the user context is updated in accordance with the collected user information or user circumstances information.

19. The method for offering a user-oriented sensory effect contents service of claim 16, wherein the user context includes at least one of location information, sex information, age information, height information, and weight information of the user, a user surrounding background information, environment parameter information of user peripheral area, and user history information.

20. The method for offering a user-oriented sensory effect contents service of claim 19, wherein the managing a user context includes collecting information on the user preference to at least one of the contents and the contents playing device by using the user history information, and
the controlling includes controlling the contents playing device in accordance with the user preference information.
